(19) United States
(12) Patent Application Publication
(10) Pub. No.: US 2005/0046400 A1
(43) Pub. Date: Mar. 3, 2005

(54) Controlling operation of a voltage supply according to the activity of a multi-core integrated circuit component or of multiple IC components

(76) Inventor: Efraim Rotem, Haifa (IL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/442,595

(22) Filed: May 21, 2003

(51) Int. Cl. G05F 1/10

(52) U.S. Cl. 323/234

(57) ABSTRACT

A voltage supply is to power an integrated circuit (IC) component of a computer system. The component has a number of logic cores or functional blocks that are powered by the voltage supply. Each logic core can operate in multiple work capability states. Operation of the voltage supply is then controlled according to a combination of the work capability states in which the logic cores are actually operating.

### BACKGROUND

An embodiment of the invention is related to achieving power savings in electronic systems, such as mobile computing and communication products (e.g. notebook computers), having integrated circuits.

Power savings is an important part of operating an electronic system, not just for achieving energy conservation in general but also for extending the run-time of a battery-powered mobile product such as a notebook or laptop computer.

A typical notebook personal computer includes the following components. A battery is used as the main power supply of the computer. The battery supplies power to all of the different components of the computer including, for example, the display, the mass storage device, and computing logic. The computing logic typically includes a processor die and a system chipset, both of which are examples of integrated circuits. The chipset allows the processor to communicate with I/O devices and with main memory in the computer. Modern integrated circuits use relatively low, DC supply voltages on the order of about 1 Volt, to achieve lower power consumption. Since the output voltage of the main power supply can be substantially greater than the input supply voltage of integrated circuits, e.g. 10 Volts or more, a step down switching regulator is often used to provide this relatively low, well regulated DC voltage to the integrated circuits at power levels of 20 Watts and more.

A popular power saving technique implemented in notebook computers is to use integrated circuits that can operate in a state or mode of reduced work capability that leads to reduced power consumption. For example, some processors, such as the PENTIUM 4 brand of processors by Intel Corp. of Santa Clara, Calif., can operate according to an internal core clock signal that can be on/off modulated. This is an example of processor clock ‘throttling’ which temporarily puts the processor in a non-active mode, which in turn significantly reduces processor power consumption. Another technique that has been used with PENTIUM 4 processors is reducing a processor frequency as well as reducing the processor's power supply voltage. This mode is sometimes referred to as a “P State” or Performance State”. A set of power states or work capability modes have also been defined to place the processor in various ‘sleep’ states. In a sleep state, some or all of the computing and I/O functions of the processor are essentially shut down, by either stopping a clock signal to them or reducing their supply voltage to a minimum level. This reduction in work capability causes a very significant reduction in the load current of the switching regulator that supplies power to the processor.

Another way of reducing power consumption is suggested in commonly assigned U.S. Pat. No. 5,945,817 to Nguyen, where a narrower, rather than broader, range is maintained for the processor input supply voltage. That patent describes a variable voltage supply that is coupled to receive a power status signal from a processor, where this signal indicates a power consumption mode in which the processor operates. The voltage supply provides the processor with a supply voltage that is a function of the power status signal and that is maintained in the narrower range, to reduce the power consumption of the processor, when the status signal indicates that the processor is idle.

Yet another way of reducing power consumption in a computer system is described in commonly assigned U.S. patent application Ser. No. 10/179,638, filed Jun. 24,2002. There, a method is described that involves generating a signal that indicates a state of reduced work capability in an IC component that is being powered by a voltage supply. The signal is applied to increase the power efficiency of the supply, while the supply is powering the IC in its reduced work capability state.

### BRIEF DESCRIPTION OF THE DRAWINGS

The invention is illustrated by way of example and not by way of limitation in the figures of the accompanying drawings in which like references indicate similar elements. It should be noted that references to “an” embodiment of the invention in this disclosure are not necessarily to the same embodiment, and they mean at least one.

FIG. 1 is a flow diagram of a method for controlling the operation of a voltage supply.

FIG. 2 is a conceptual block diagram of a computer system with a controlled voltage supply powering multiple, logic cores.

FIG. 3 is a conceptual diagram of an IC component with multiple cores and an activity circuit for controlling a power supply to the component.

FIG. 4 is a conceptual diagram of a dual processor computer system.

### DETAILED DESCRIPTION

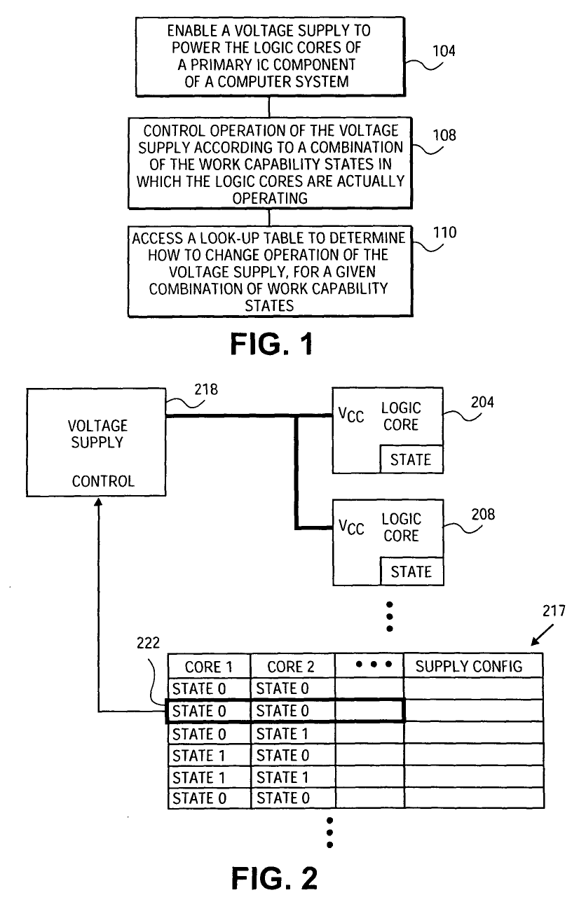

Various techniques for further reducing power consumption in a computer system are described. FIG. 1 shows a flow diagram of such a technique. Starting with operation 104, a voltage supply that is to power a primary IC component of a computer system is enabled. Examples of the primary IC component include a processor, system interface (chipset), and a main memory subsystem. The primary IC component has a number of logic cores (also referred to as functional blocks) that are powered by the voltage supply. Thus, in the case of a processor, there can be, for example, two or more processor cores that are being powered by the voltage supply. Each logic core can operate in multiple, different work capability states. One distinguishing feature between these states is that of significantly different power consumption levels. For example, each logic core may be designed to operate in a normal or active state where it is expected to consume much more power than in a sleep or very low activity state. Intermediate activity states may also be defined for one or more of the logic cores. Note that the techniques described here are not limited to processor cores; other types of functional blocks such as execution units or cores, internal cache memory, clusters, etc. can also benefit from the described power consumption reduction techniques.

Once power has been applied to the primary IC component, and the computer system as a whole has become more or less fully operational, the operation of the voltage supply is controlled according to a combination of the work capability states in which the logic cores or functional blocks are operating (operation 108). In other words, the computer system itself will control the operation of the voltage supply, as a function of the combination of the states in which the logic cores are operating. When the combination changes to one which is expected to result in reduced power consumption, for the logic cores as a group, activity in some circuitry of the voltage supply is reduced in response, in an effort to reduce the overall power consumption of the system.

Contemplated reductions in the activity of the circuitry of the voltage supply include, for example, (a) turning off a phase of a multi-phase, synchronous switching regulator in the voltage supply, (b) changing the regulator to asynchronous operation, (c) changing the switching frequency of the voltage regulator, and (d) reducing the output voltage of the voltage supply. In the latter case, the logic cores should be able to operate at different power supply voltage levels.

The following example is provided to explain the operations described above as well as how they may reduce power consumption in a computer system. Consider a system in which there are only two, main logic cores in the primary IC component that is being powered by the voltage supply. Also assume that each core can operate in two, different, work capability states, that is one low power consumption state and one high power consumption state. This means that there are four different combinations of work capability states in which the primary IC component can operate. Assume further that the two cores are essentially replicates and accordingly are expected to draw essentially the same amount of maximum power in their respective, normal states. This yields three different levels of expected, maximum current or power, for the IC component as a whole, as shown in the table below.

| | | |
|---|---|---|
| | | Synchronous |
| | Expected | switching |
| Group | maximum power | regulator |

| Core 1 | Core 2 | draw of group | configuration |
|---|---|---|---|
| high | high | highest | all phases |
| | | | operational |
| high/low | low/high | medium | turn off one or |
| | | | more phases |
| low | low | lowest | asynchronous |

Note that the differences between the lowest, highest, and medium expected maximum power levels can be quite large, especially in a high performance, highly integrated, primary IC component such as a processor, chipset, or memory subsystem. It has been determined that most voltage supplies cannot operate at peak efficiency at such widely disparate output power levels. Accordingly, to address this problem, different configurations in the voltage supply are defined, to improve its power efficiency at each of the widely disparate output power levels. For example, it has been determined that in multi-phase, switching regulators that are designed to provide the power supply voltage to a primary IC component, power efficiency improves at lower output power levels (and lower maximum current levels) by turning off one or more phases of the regulator. In addition, in some cases, if the expected current draw or power level has dropped sufficiently, changing a synchronous switching regulator to asynchronous operation will improve power efficiency at those lower output power levels. These options are shown in the table above.

Although in the example above, each logic core is assumed to operate in only two, different work capabilities states, additional work capability states may be defined. For example, an intermediate state may be defined that is expected to have a maximum power draw that is between the lowest and highest combinations. Such a state, could be for example, where one or both of the logic cores is operating in a reduced clock frequency mode which exhibits lower maximum expected power draw at the expense of lower performance.

To implement the above described technique, a look-up table may be used that contains the information shown in the table above. The computer system in that case would access the table using the work capability state in which each of the logic cores is currently operating, to determine how to control or change the voltage regulator (operation 110 in FIG. 1). Note that accessing the look-up table in this case may also give an indication of the maximum expected power consumption of the multiple logic cores as a group or combination, and in particular the maximum expected power draw or current draw. The references to “maximum” expected current or power draw is intended to mean an upper, nominal limit. Thus, in practice, the multiple cores may not actually reach this upper limit.

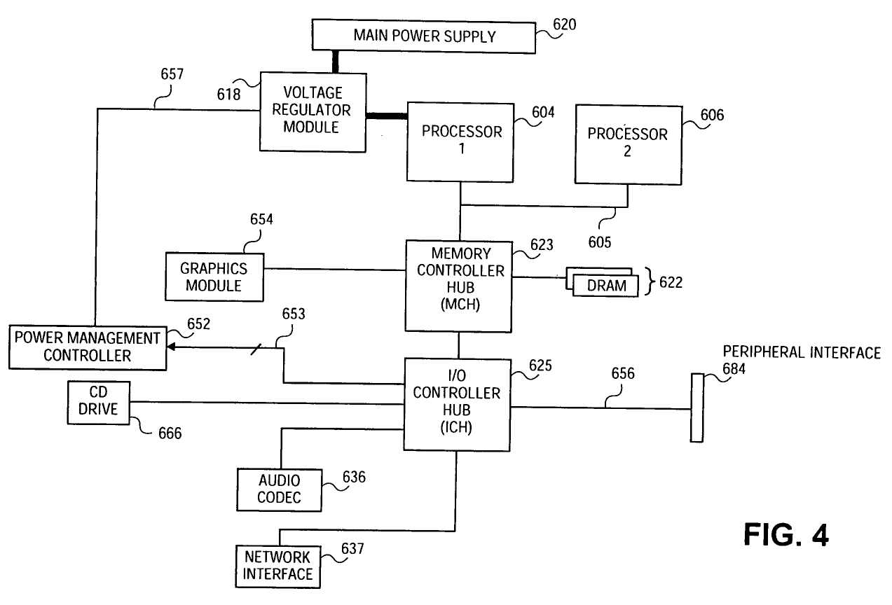

The look-up table may be programmable, to allow the system to load the table with any desired algorithm that determines the voltage supply changes as a function of a given combination of work capability states of the multiple cores. Different algorithms may be loaded, depending upon the design of the voltage supply (and its available configurations for improved power efficiency), the number and types of work capability states of the logic cores, as well as the maximum expected power draw of the logic cores as a group for each combination work capability state. This programming of the look-up table may be performed by firmware or a basic I/O system (BIOS) program executing on the main carrier substrate (e.g., motherboard) of the computer system. An example of such a computer system is given below in connection with FIG. 4.

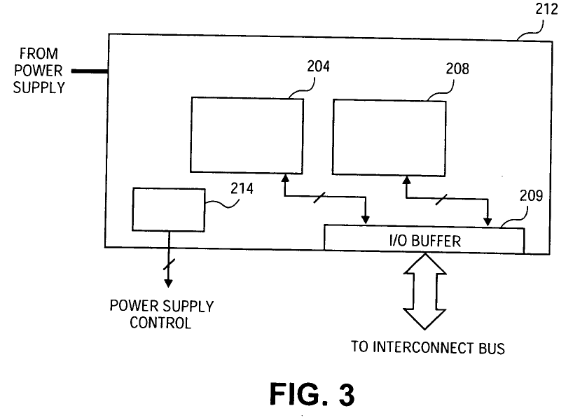

Turning now to FIG. 2, a conceptual block diagram of a computer system with a controlled voltage supply 218 powering multiple, logic cores 204, 208, . . . is illustrated. The voltage supply 218 is connected to the multiple logic cores 204, 208, . . . via a power conductor, to the supply voltage or Vcc inputs of each core. A look-up table 217 is provided in the system, to implement an algorithm for the reduction in power consumption described above. For each combination of work capability states of the multiple cores, a particular voltage supply configuration may be defined in the look-up table. An entry 222 of the table 217 is selected that meets the combination of the states in which the cores are currently operating. The corresponding supply configuration defined for the selected entry 222 is then established via a control input of the voltage supply 218. As will be described below, there can be a direct connection between an activity circuit (of which the look-up table 217 is a part) and the hardware of the voltage supply 218, such that any changes in the combination state of the multiple cores is directly signaled to the voltage supply 218 via a dedicated control bus. In another embodiment, power consumption information can be transferred over an existing control bus (such as one that is also used for communicating voltage control signals to the supply 218). It is also possible to control the supply by means of firmware or software that implements an algorithm whose input is the combination power state of the multiple cores and whose output indicates the desired configuration of the supply 218. In addition, the activity circuit including the look-up table 217 may be part of the same primary IC component that contains the multiple cores 204, 208, . . . That embodiment is illustrated in FIG. 3.

In FIG. 3, a conceptual diagram of a primary IC component 212 with multiple cores 204 and 208 and an activity circuit 214 is shown. The multiple cores 204 and 208 or core function blocks are designed to perform some core function of the IC component 212. These cores 204 and 208 may be part of a single chip, multi-processor. Alternatively, each of the cores may be a separate chip, as part of a multi-chip processor module. In the case of a processor, the cores may be independent processor cores that are intended for a multi-processor computer system. In the case of a memory subsystem, for example, each core may be a memory array and its associated control logic. In such cases, the cores 204, 208 communicate with external elements via an I/O buffer 209 of the IC component. The I/O buffer 209 serves to interface the logic signaling of the cores 204, 208 with transmission line signaling of an interconnect bus (not shown.) Note that a core may alternatively be an execution unit of a processor or an internal cache memory unit, which need not have its own I/O buffers to communicate with external components.

Regardless of the type of function, each core is capable of operating in multiple, different power consumption modes. For example, in the case of a processor core, there may be five different states. The first state could be the normal operating state or also referred to as the active state, where the greatest performance may be obtained from the processor. In this state, a core function block may operate in different clock frequency modes, with a higher core clock frequency in one mode as compared to the other. The core function block can transition between such modes in response to an operating system command being executed in the computer system of which the IC component is a part.

The second state may be a lower power state which is entered into when the processor executes a particular instruction. While in this lower power state, an external signal applied to the IC component may be used to “throttle” the activity of the processor core, such that the core will execute only if this signal remains asserted and stops executing when the signal is deasserted. An example of such a state is the AutoHalt state of PENTIUM 4 processors by Intel Corp. While in the AutoHalt state, the interconnect bus clock remains running and the processor core may still execute bus snoops and respond to interrupts.

Yet another possible work capability state is similar to the AutoHalt state described above, except that certain interrupts will not be serviced immediately. The core may enter this state upon a particular external control signal to the IC component being asserted. This signal may be the STPCLK # signal which, when asserted, places a PENTIUM 4 processor into a stop-grant state during which the processor core can process a system bus snoop but will not immediately service certain interrupts. The processor may stay in this state, until a snoop on the system interconnect bus has been serviced (whether by the processor or by another agent on the system bus). After the snoop has been serviced, the processor may return to the AutoHalt state.

Each core may also be designed to enter a sleep state which is considered a very low power state. For example, in the case of a processor core, the sleep state is one in which the processor maintains its context, but has stopped all internal clocks (thereby disabling most of its internal functions). Again, the core may enter such a state upon the assertion of an external control signal from outside of the core (or outside of the IC component). A processor in the sleep state may not be able to snoop bus events or respond to snoop transactions or latch interrupt signals. A transition out of such a sleep state may be had by deasserting the external control signal. In yet another state, such as the P state introduced above, a core may also run at a lower clock frequency and at its nominal (or lowered) supply voltage, yet still have all of its internal functions fully operational.

Returning now to FIG. 3, the activity circuit 214 is to provide a signal, based on a combination power consumption mode in which the core function blocks are operating, that is to be used for increasing an efficiency of the power supply that is powering the IC component 212. The activity circuit 214 may be implemented using state machine logic or a lookup table as described above. The activity circuit 214 may have knowledge of the power consumption mode of each core 204, 208 at any given time during normal operation. Depending upon the combination power consumption mode in which the core function blocks are operating, the activity circuit 214 may provide a signal that will be used to change the configuration of the power supply so as to increase efficiency, while the blocks are operating in that combination power mode. This power supply control signal may indicate a single, binary variable. One value of the variable indicates that no changes be made in the power supply, while another value indicates that some change be made. A further signal may be provided (by the activity circuit) which indicates a more specific change to be made in the power supply. Thus, a multi-bit binary value may be generated by the activity circuit 214, to represent a number of different power supply configurations that are possible. As mentioned above, these signals may be fed directly to the power supply which will contain logic and analog circuitry needed to change its configuration in response to the control signals.

Referring now to FIG. 4, a block diagram of a dual processor, computer system is shown, as yet another embodiment of the invention. The computer system has a main power supply 620, which, as mentioned above, may include a rechargeable battery and/or an AC to DC power converter. Another alternative is a fuel cell. The main power supply 620 supplies the power demanded by a voltage regulator module (VRM) 618, as well as the power required by other components of the system including for example a compact disc (CD) drive 666, a display screen (not shown), and a peripheral interface 684. The VRM 618 provides a regulated, DC output voltage that will be used by the primary IC components of the system which include, in this embodiment of the invention, processor cores 604, 606, a memory controller hub (i.e., MCH) 623, and an I/O controller hub (i.e. ICH) 625. The latter two components may be part of the system interface or chipset. The processor cores 604, 606 are communicatively coupled to each other and the MCH 623 in this embodiment, via a multi-drop, system bus 605. As an alternative, a serial, point-to-point link can connect the processors 604, 606 to each other, while a pair of additional links can connect them to the memory subsystem (via the system chipset).

The MCH 623 and ICH 625 are part of the system core logic that also includes main memory 622 composed of dynamic random access memory (i.e. DRAM) and graphics module 654, all of which may be conventional components. A serial interface bus 656 connects with a peripheral interface 684 (such as a Universal Serial Bus port or a High Speed Serial Bus port). In mobile products such as notebook/laptop computers, the interface 684 allows the mobile product to communicate with a docking station or a desktop computer (not shown).

The ICH 625 also has audio codec capability 636, such as a popular, high quality, 16-bit audio architecture for personal computers that is used in many modern desktop systems. In addition, a network interface 637 may also be provided to support a telephone line modem connection or a high speed data network connection. Finally, the ICH 625 also has a direct interface to a mass storage device such as a CD drive 666, which may be in addition to the support for a hard disc drive (not shown). It will be appreciated by those of ordinary skill in the art that a wide range of different logic functions may be included in the system chipset of a computer system, including an arrangement different than the one shown in FIG. 4.

In the embodiment of the invention shown in FIG. 4, the signals 653 indicate the current, combination work capability state of the processor cores 604, 606, are generated by the chipset, and are routed to power management controller 652. The power management controller 652 monitors and manages power consumption in the entire system, so it may be convenient to allow this controller 652 to also control the configuration of the VRM 618 as otherwise described above, based on a combination work capability mode of the dual processor cores 604, 606 indicated by the signals 653. It is the power management controller 652 which then communicates, on a low speed bus 657, with the VRM 618 to increase the latter's power efficiency. This is an alternative to the dedicated, direct connection between the activity circuit and the voltage supply of the embodiment shown in FIG. 2. Note that the power management controller 652 may be a dedicated, packaged IC component of the system, or it may be part of another packaged IC device in the system.

According to another embodiment of the invention, the system can estimate the combined power consumption of multiple, different, primary IC components of the system (based on the power consumption modes in which the components are operating). In that case, still referring to FIG. 4, the signals 653 would indicate the current power consumption modes of not just the processor cores 604, 606 but also of the system chipset, for example. This information could then be used (e.g. by the power management controller 652 running an algorithm) to request a change in the configuration of the regulator module 618 so that the power efficiency of the regulator improves during operation.

To summarize, various embodiments of a method and apparatus for controlling the operation of a voltage supply, according to the activity of a multi-core IC component that is being powered by the supply, have been described. In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. A method comprising:
enabling a voltage supply to power an integrated circuit (IC) component of a computer system, the component having a plurality of logic cores that are powered by the voltage supply, each logic core to operate in a plurality of different work capability states; and
controlling operation of the voltage supply according to a combination of the work capability states in which the plurality of logic cores are operating.

2. The method of claim 1 wherein there are only two of said plurality of logic cores, and there are five different combinations of said plurality of work capability states.

3. The method of claim 1 wherein the plurality of work capability states include a normal mode, a reduced clock frequency mode, and a sleep mode.

4. The method of claim 1 further comprising:
accessing a look-up table using the work capability state in which each of the plurality of logic cores is operating, to determine how to control the voltage supply to improve power efficiency in the work capability states in which the plurality of logic cores are operating.

5. The method of claim 4 wherein the look-up table is programmable, the method further comprising executing firmware to load the table with information that determines how to change operation of a voltage supply to improve power efficiency at a given combination of work capability states of a plurality of logic cores.

6. The method of claim 1 wherein the controlling includes signaling that a power consumption level of the plurality of logic cores as a combination has dropped and, in response, reducing activity in some circuitry of the voltage supply.

7. The method of claim 6 wherein the reduction in activity includes one of (a) turning off a phase of a multi-phase, synchronous switching regulator in the voltage supply, (b) changing the regulator to asynchronous operation and (c) changing a switching frequency of the regulator.

8. The method of claim 1 wherein the controlling includes signaling that a power consumption level of the plurality of logic cores as a combination has dropped and, in response, reducing an output voltage of the voltage supply.

9. The method of claim 6 further comprising:
accessing a look-up table using the work capability state in which each of the plurality of logic cores is operating, to determine an indication of the power consumption of the plurality of logic cores as a combination.

10. The method of claim 9 wherein the indication is an upper limit of expected current draw of the plurality of logic cores as a combination.

11. An integrated circuit (IC) component comprising:
a plurality of core function blocks to perform a core function of the IC component, each block being capable of operating in a plurality of different power consumption modes;
an activity circuit to provide a signal based on a combination power consumption mode in which the plurality of core function blocks are operating, to be used for increasing an efficiency of a power supply that is powering the IC component.

12. The component of claim 11 wherein the plurality of core function blocks are part of a single chip multi-processor.

13. The component of claim 11 wherein the plurality of core function blocks are processor cores.

14. The component of claim 13 wherein each core function block can operate in one of an active state, a stop clock state, a sleep state, and a deep sleep state.

15. The component of claim 14 wherein each core function block can further operate in one of a first and second clock frequency modes, with a higher core clock frequency in the first mode, in response to an operating system command.

16. The component of claim 11 wherein said signal indicates a binary variable, with one value indicating no change be made in the power supply and another value indicating that some change be made in the power supply, and wherein the activity circuit is to provide a further signal of the IC component which indicates a more specific change to be made in the power supply.

17. The component of claim 16 wherein said signal and said further signal are to be fed directly to the power supply.

18. A system comprising:
a system bus;
a plurality of processor cores coupled to the system bus;
a rechargeable battery;
a voltage regulator module coupled between the battery and the plurality of processor cores to power the plurality of processor cores; and
activity logic to provide a signal, based on a combination work capability mode in which the plurality of processor cores are operating, to be used for increasing power efficiency of the voltage regulator module.

19. The system of claim 18 wherein there are two processor cores and the combination mode indicates that both of the processor cores are in a normal activity mode.

20. The system of claim 18 wherein there are two processor cores and the combination mode indicates that only one of the processor cores is in a normal activity mode.

21. The system of claim 18 wherein there are two processor cores and the combination mode indicates that both of the processor cores are in a sleep mode.

22. The system of claim 18 wherein the activity logic includes a programmable look-up table whose output indicates how to configure the voltage regulator module, for an input combination work capability mode.

23. The system of claim 18 wherein the activity logic includes a programmable look-up table whose entries indicate one of (a) a number of active phases of a switching regulator, (b) synchronous or asynchronous operation for a switching regulator, (c) reduced switching frequency, and (d) a reduced supply voltage level.

24. The system of claim 18 further comprising a power management controller coupled between the activity circuit and the voltage regulator module, to communicate a configuration change to the module.

25. The system of claim 18 further comprising:
a control bus to which the regulator and the activity logic are coupled, the activity logic to share the control bus with other devices of the system, in signaling power consumption information, regarding the plurality of processor cores, to the regulator.

26. A system comprising:
a first integrated circuit (IC) component to operate in any one of a plurality of different, power consumption modes, to perform a primary function of the system;
a second IC component communicatively coupled to the first IC via a communication link, the second IC component to operate in any one of a plurality of different power consumption modes, to perform another primary function of the system;
a voltage regulator coupled to power the first and second IC components; and
control logic that estimates the combined power consumption of the first and second IC components and in response signals the voltage regulator to change its configuration so that power efficiency in the regulator increases while the IC components are operating in said respective power consumption modes.

27. The system of claim 26 wherein the first IC component is a processor and the second IC component is a system chipset.

28. The system of claim 26 wherein the communication link is a point-to-point serial bus.

29. The system of claim 26 wherein the first and second IC components are both processors.
